(19) United States
(12) Patent Application Publication
(10) Pub. No.: US 2020/0252225 A1
(43) Pub. Date: Aug. 6, 2020

(54) Power Reuse in Power-Over-Ethernet Systems

(71) Applicant: HEWLETT PACKARD ENTERPRISE DEVELOPMENT LP, Houston, TX (US)

(72) Inventor: Yu Liu, Santa Clara, CA (US)

(21) Appl. No.: 16/263,550

(22) Filed: Jan. 31, 2019

(51) Int. Cl. H04L 12/10; H04L 12/40; G06F 1/26; G06F 1/3206

(52) U.S. Cl. CPC H04L 12/10; G06F 1/3206; G06F 1/266; H04L 12/40045

(57) ABSTRACT

A Power-Over-Ethernet (PoE) powered device comprises a power interface coupled by an Ethernet cable to a PoE port of a power source equipment device, a power monitor coupled to the power interface to obtain at least two voltage measurements and at least two current measurements of a power signal supplied on the Ethernet cable, and a processor coupled to the power monitor to compute a cable resistance value for the Ethernet cable as a function of the at least two voltage and current measurements. Intelligent circuitry in a PoE PD may monitor and compute an actual cable resistance value and enable the PD to more fully utilize the power actually supplied from the PSE.

### BACKGROUND

The term Power-over-Ethernet (“PoE”) refers to a class of electronic devices, and systems which utilize such devices, in which both operational electrical power and data are transmitted along twisted pair Ethernet cabling. PoE systems allow a single Ethernet cable to provide both a data connection and a power connection between a power and data source (so-called “Power Source Equipment” or “PSE”) and a Powered Device (“PD”), without requiring separate cabling or other connections for these two purposes. A PD may be, for example, a wireless (e.g., WiFi) access point (“AP”) providing wireless network access to one or more other devices. Other PDs include those in the category of Internet-of-Things (“IoT”) devices. IoT devices are physical devices of various types which may incorporate electronics, software, sensors, actuators, and the like, along with supporting connectivity to enable them to connect, collect, and exchange data and control signals with other devices, including computers and computer networks (WANs, LANs, VPNs, the Internet, etc.). The evolution and proliferation of IoT devices is providing increasing opportunities for more direct integration of the physical world and computer-based systems, resulting in efficiency improvements, economic benefits, and overall convenience in performing many day-to-day tasks.

A plurality of PDs, such as APs, IoT devices and others, may receive their power from a single PSE device. A PSE device is connected to a primary power source, in order for it to provide (distribute) the power from that primary power source to the connected PDs. According to applicable standards, a PSE device may be assigned a rating specifying a minimum amount of power the PSE device is capable of delivering to connected PDs. A PD, in turn, may be assigned rating specifying the maximum amount of power it is permitted to draw from a PSE device.

### BRIEF DESCRIPTION OF THE DRAWINGS

For a detailed description of various examples, reference will now be made to the accompanying drawings, in which:

FIG. 1 is a block diagram of a PoE system in accordance with one example;

FIG. 2 is a block diagram of one powered device and the power source equipment device from the example of FIG. 1;

FIG. 3 is a schematic representation of a PoE system such as in the example of FIG. 1;

FIG. 4 is a flowchart illustrating a method of operating a powered device in a PoE system;

FIG. 5 is a flowchart illustrating a method of operating a PoE system including a powered device and a power source equipment device;

FIG. 6 is a flowchart illustrating a method of operating a power source equipment device in a PoE system;

FIG. 7 is a block diagram representing a computing device implementing a powered device in a PoE system according to one or more disclosed examples;

FIG. 8 is a block diagram representing a computing device implementing a powered device in a POE system according to one or more disclosed examples; and

FIG. 9 is a block diagram representing a computing device implementing a power source equipment device according to one or more disclosed examples.

### DETAILED DESCRIPTION

As noted above, a plurality of PDs may be coupled to one PSE device in a PoE system. Applicable industry standards for PoE systems include the IEEE 802.3AF standard, the IEEE 802.3AT standard, and the IEEE 802.3BT standard. A PSE device such as an Ethernet switch may have a plurality of PoE ports providing power to a plurality of PDs.

The aforementioned applicable standards specify that PSE devices should supply a minimum amount of power at their PoE ports. The same standards specify that a given PD should only draw a maximum amount of power from the PoE port of a PSE device. Margins are established between the minimum power ratings of PSE devices and the maximum power ratings of PDs, in order to ensure reliable operation despite implementation-specific variables such as the cable resistances of the Ethernet cables connecting PDs to PSE devices.

In many actual implementations, however, a PoE system including one or more PDs coupled to a PSE device may be implemented with Ethernet cables substantially less than 100 meters in length. In addition, improvements in the production of Ethernet cables have led to reductions in overall cable resistance per unit of length below the resistance assumed by the standards. Consequently, in many implementations of PoE systems, a PSE device may be capable of providing more power than the amount of power actually necessary to power the connected PDs. That is, in many implementations, the power loss due to Ethernet cable resistance is appreciably less than the power loss provided for by compliance with applicable standards, resulting in a net surplus of power in the PoE system. This surplus power remains unused by PDs.

However, if the actual power loss due to cable resistances is known in a given implementation, the aforementioned surplus power may be exploited in various ways, such as by increasing the power provided to selected PDs, without compromising the reliability of the system and yet remaining in substantial conformance with applicable standards.

In accordance with examples described herein, the surplus power available in a PoE system may be reused by PDs connected to a PSE device. This is achieved in part through the computation of resistance values for Ethernet cabling connecting PDs to a PSE device in a PoE system.

In this description, for purposes of explanation, numerous specific details are set forth in order to provide a thorough understanding of the examples disclosed herein. It will be apparent, however, to one skilled in the art that the disclosed example implementations may be practiced without these specific details. In other instances, structure and devices are shown in block diagram form in order to avoid obscuring the disclosed examples. Moreover, the language used in this disclosure has been principally selected for readability and instructional purposes and may not have been selected to delineate or circumscribe the inventive subject matter, resorting to the claims being necessary to determine such inventive subject matter. Reference in the specification to “one example” or to “an example” means that a particular feature, structure, or characteristic described in connection with the examples is included in at least one implementation.

The term “information technology” (IT) refers herein broadly to the field of computers of all types, computing systems, and computing resources, the software executed by computers, as well the mechanisms, physical and logical by which such technology may be deployed for users.

The terms “computing system” and “computing resource” are generally intended to refer to at least one electronic computing device that includes, but is not limited to including, a single computer, virtual machine, virtual container, host, server, laptop, and/or mobile device, or to a plurality of electronic computing devices working together to perform the function(s) described as being performed on or by the computing system. The term also may be used to refer to a number of such electronic computing devices in electronic communication with one another.

The term “cloud,” as in “cloud computing” or “cloud resource,” refers to a paradigm that enables ubiquitous access to shared pools of configurable computing resources and higher-level services that can be rapidly provisioned with minimal management effort; often, cloud resources are accessed via the Internet. An advantage of cloud computing and cloud resources is that a group of networked computing resources providing services need not be individually addressed or managed by users; instead, an entire provider-managed combination or suite of hardware and software can be thought of as an amorphous “cloud.”

The term “non-transitory storage medium” refers to one or more non-transitory physical storage media that together store the contents described as being stored thereon. Examples may include non-volatile secondary storage, read-only memory (ROM), and/or random-access memory (RAM). Such media may be optical or magnetic.

The terms “application” and “function” refer to one or more computing modules, programs, processes, workloads, threads and/or a set of computing instructions executed by a computing system. Example implementations of applications and functions include software modules, software objects, software instances and/or other types of executable code. Note, the use of the term “application instance” when used in the context of cloud computing refers to an instance within the cloud infrastructure for executing applications (e.g., for a customer in that customer's isolated instance).

As noted above, the term Power-over-Ethernet (“PoE”) refers to a class of electronic devices, and systems which utilize such devices, in which both operational electrical power and data are transmitted along twisted pair Ethernet cabling. PoE allows a single cable to provide both a data connection and a power connection between a power and data source and a PoE device, without requiring separate cabling or other connections for these two purposes. Many PoE devices are those in the category of “Internet-of-Things” or “IoT” devices. IoT devices include physical devices of various types which incorporate electronics, software, sensors, actuators, and the like, and supporting connectivity to enable them to connect, collect, and exchange data and control signals with other devices, including computers and computer networks (WANs, LANs, VPNs, the Internet, etc.). The evolution and proliferation of IoT devices is providing increasing opportunities for more direct integration of the physical world and computer-based systems, resulting in efficiency improvements, economic benefits, and overall convenience in performing many day-to-day tasks.

As also noted above, the applicable standards specify that PSE devices should supply a minimum amount of power at their PoE ports. The same standards specify that a given PD should only draw a maximum amount of power from the PoE port of a PSE device. Margins are established between the minimum power ratings of PSE devices and the maximum power ratings of PDs, in order to ensure reliable operation despite implementation-specific variables such as the cable resistances of the Ethernet cables connecting PDs to PSE devices. Cable resistance can vary depending upon multiple factors, including the quality, rating, and length of a cable, for example. Cable resistance is primarily a linear function of cable length, such that a cable that is one-half the length of another will have one-half of the resistance.

According to the IEEE standards, the power margins allocated for power loss due to cable resistance are based upon a 100-meter cable length. For the IEEE 802.3AF standard, a power margin of 2.45 watts is allocated, corresponding to a presumed 20-ohm loss over 100 meters of Category 3 (“CAT3”) Ethernet cable. For the IEEE 802.3AT standard, a margin of 4.5 watts is allocated, corresponding to a presumed 12.5-ohm loss over 100 meters of Category 5E (“CAT5E”) Ethernet cable. For the 802.3BT standard, which increases the maximum PD power available by utilizing additional conductor pairs in an Ethernet cable, a power margin of 9 watts is allocated, corresponding to a presumed 12.5-ohm loss over 100 meters of CAT5E Ethernet cable.

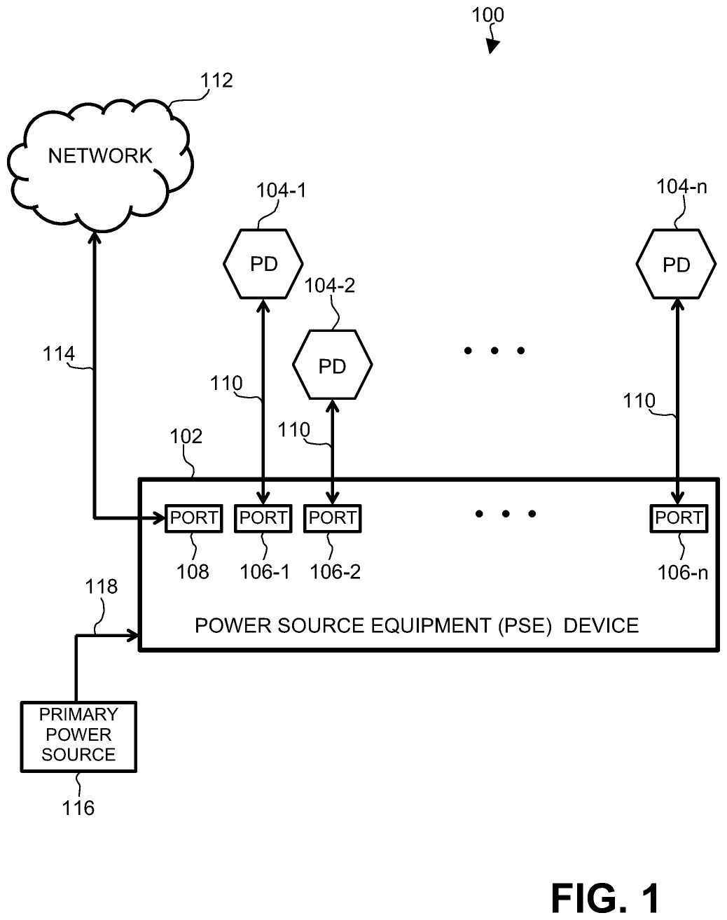

Referring to FIG. 1, there is shown a PoE system 100 which includes a power source equipment (PSE) device 102 and a plurality of powered devices (PDs) 104-1, 104-2, . . . 104-n (collectively, “PDs 104”). In this example, PSE device 102 may be an Ethernet switch having a plurality of PoE ports 106-1, 106-2, . . . 106-n (collectively, “PoE ports 106”) for providing power and data to PDs 104. Many different types of PDs are known, and different PDs have different functionality, different power requirements, and different power usage profiles.

PSE device 102 in the present example further includes a connection port 108 for connecting PSE device 102 to a network 112, thereby facilitating network connectivity for PDs 104 to communicate with other network-connected devices, including network servers and the like. Each PD 104 is connected to PSE device 102 by means of an Ethernet cable 110. Another Ethernet cable 114 provides a connection between network 112 and PSE device 102.

As shown in FIG. 1, a primary power source 116 provides power over a power connection 118 to PSE device 102. Some of the power from power source 116 is used for operational power for PSE device 102 itself. PSE device 102 also distributes power from primary power source 116 to each PD 104 by cables 110 for the operational power required by PDs 104.

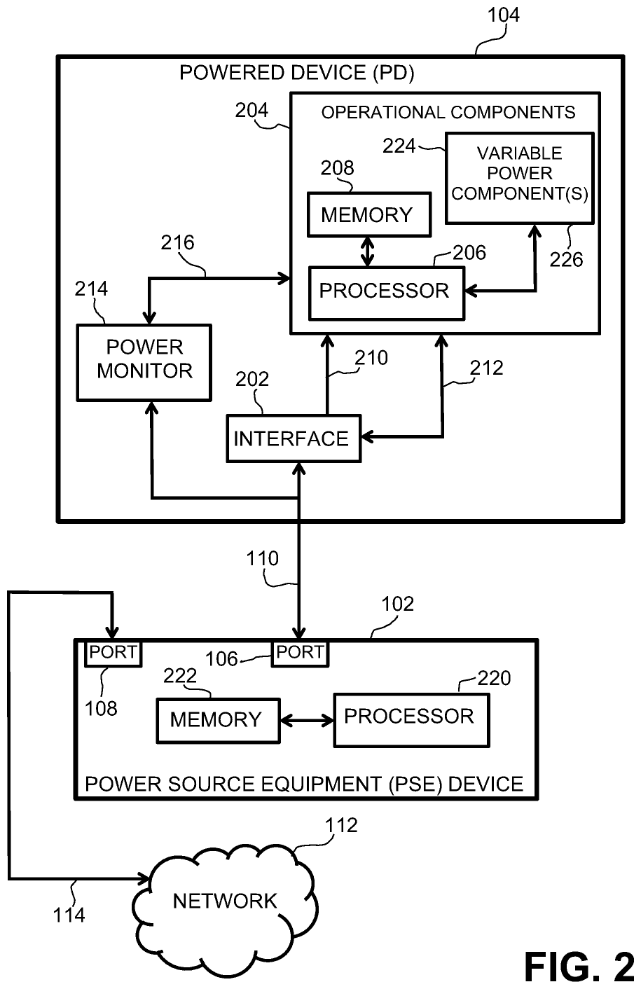

FIG. 2 shows one of the plurality of PDs 104 from FIG. 1, coupled to PSE device 102 by Ethernet cable 110. (It is to be noted that for clarity, only one PoE port 106 is shown in FIG. 2, and it is to be understood that PD 104 may have any number n≥1 of PoE ports 106, as represented in FIG. 1). As shown in FIG. 2, PD 104 includes an interface 202 providing power received by Ethernet cable 110 to operational components 204 of PD 104. As noted, many types of PDs are known, ranging from simple IoT devices such as sensors, LED lights, and so on, to more sophisticated and complex devices such as wireless access points (APs), such as WiFi stations, which include operational circuitry along with other power-consuming components such as wireless transmitters and receivers making up operational components 204 in PD 104 of FIG. 2. The description herein of a PD device 104 comprising an access point (“AP”) is intended to be illustrative only, and not limiting with respect to the applicability of this disclosure to PoE systems including essentially any and all types of PDs, as shall be hereinafter described in further detail.

Among the operational components 204 of PD 104 may be a processor 206 coupled to memory 208. In one example, processor 206 is a microprocessor for executing programming stored in memory 208. In other implementations, processor 206 may be a microcontroller or dedicated controller logic configured to implement the functionality of PD 104 as described herein.

Depending upon the nature and implementation of PD 104, interface 202 in FIG. 2 may comprise a passive, pass-through element such as a RJ45 Ethernet connector establishing a connection between PD 104 and Ethernet cable 110. In other implementations, interface 202 may comprise functional electronic circuitry, such as, for example, a DC-to-DC transformer, a filter, and/or other power conditioning circuitry for providing appropriate operational power to operational components 204 via a power connection 210. Data carried on Ethernet cable 110 may also be exchanged with operational components 204 via a data connection 212 through interface 202.

The example PD 104 of FIG. 2 may include one or more variable power component(s) 224 in operative communication with processor 206 by means of a connection 226. In one example in which PD 104 comprises an AP, variable power component(s) 224 include at least one radio-frequency wireless transceiver for establishing wireless communication between PD 104 and one or more remote wireless devices (not shown). Variable power component(s) 224 such as wireless transceiver circuitry may be operationally adjusted and controlled into different operating states, where changes in the operating state may result in corresponding changes (increases or decreases) in their operational power usage. In the case of a wireless transceiver circuitry, for example, more or less power may be supplied to and used by such circuitry in order to respectively increase or decrease the communication range of the wireless transceiver. Other types of PDs may have other variable power components. For example, a PD such as PD 104 in FIG. 2 may itself be a PSE device, such that the power supplied to the PSE device determines the amount(s) of power that is available for it to distribute, in turn, to further PoE powered devices.

The example PD 104 of FIG. 2 further includes a power monitor 214 coupled to the twisted pair(s) of Ethernet cable 110 used to provide power to PD 104. One function of power monitor 214 is to provide measurements for determining the resistance of Ethernet cable 110, in order to determine the extent to which a surplus may exist between the power available at PoE port 106 and the power required or used by PD 104.

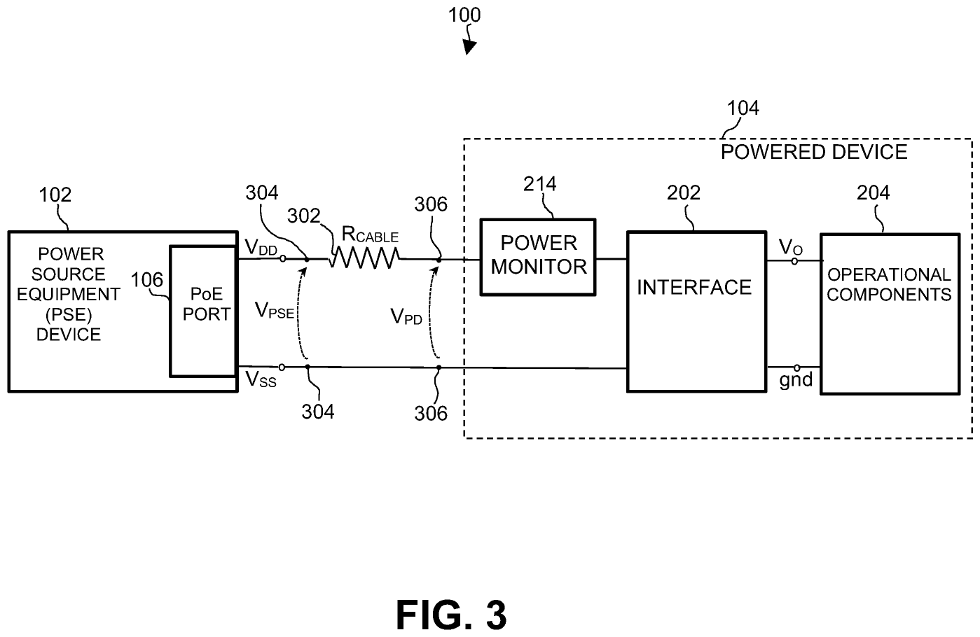

Referring to FIG. 3, there is shown a schematic diagram representation of PoE system 100 of FIG. 1. As schematically represented in FIG. 3, PoE system 100 includes PSE device 102, one of the plurality of PDs 104 coupled to PSE device 102, including interface 202, operational components 204, and power monitor 214. In the schematic of FIG. 3, Ethernet cable 110 is represented by a resistor 302. (As with FIG. 2, it is to be noted that for clarity, only one PoE port 106 is shown in FIG. 3, and it is to be understood that PD 104 may have any number n≥1 of PoE ports 106, as represented in FIG. 1).

PSE 102 provides power to PD 104 in the form of a voltage V_{PSE} applied to a source end 304 of Ethernet cable 110, the total voltage V_{PSE} equaling the difference V_{DD}-V_{SS} as represented in FIG. 3. The non-zero resistance R_{CABLE} of Ethernet cable 110 is such that the voltage V_{PD} at a load end 306 of Ethernet cable 110 is reduced. It is this voltage, and the corresponding current, that is measured by power monitor 214.

In one example, power monitor 214 comprises circuitry for taking current and voltage measurements at load end 306 of Ethernet cable 110. Such measurements provided by power monitor 214 can be utilized by processor 206 to determine a measured resistance value R_{CABLE} for Ethernet cable 110.

In this example, power monitor 214 may take first current and voltage measurements from load end 306 of Ethernet cable 110 at a first time T1, to obtain values I₁ and V_{PD1}, respectively. At a different time T2, power monitor 214 may take second current and voltage measurements from Ethernet cable 110, to obtain values I₂ and V_{PD2}, respectively. Times T1 and T2 may be chosen such that the current values I₁ and I₂ are different. For example, power monitor 214 may take first current and voltage measurements during an initialization process for PD 104, and take second current and voltage measurements during a subsequent operational state of PD 104, where the current drawn by PD 104 is greater than during the initialization process. Power monitor 214 may be configured to take multiple or periodic current and voltage measurements until such time as a pair of measurements reflecting two distinct current values I₁ and I₂ are obtained.

Once the necessary current and voltage measurements have been obtained by power monitor 214, the measurements may be provided via a connection 216 to processor 206, thereby enabling processor 206 to compute a resistance value for Ethernet cable 110, according to the following equations:

First, according to Ohm's law, for a given pair of voltage readings, the following relations exist:

V_{PSE1}=R_{CABLE}+I₁+V_{PD1} Equation (1)

V_{PSE2}=R_{CABLE}+I₂+V_{PD2} Equation (2)

where V_{PD1} and I₁ are readings by power monitor 206 at a first time and where V_{PD2} and I₂ are readings by power monitor 206 at a second time characterized by a different current value.

Also:

$${V}_{P S E} = \frac{( {V}_{PD 2} \times {I}_{1} ) - ( {V}_{P D 1} \times {I}_{2} )}{{I}_{1} - {I}_{2}} \qquad Equation ( 3 )$$

where V_{PSE} is a constant, being the voltage supplied by PSE 102 at PoE port 106.

Having obtained the two current/voltage readings, processor 206 may then compute a measured resistance value R_{CABLE} according to the following relation:

$${R}_{CABLE} = \frac{( {V}_{P D 2} - {V}_{P D 1} )}{{I}_{1} - {I}_{2}} \qquad Equation ( 4 )$$

Thus, from Equation (4), processor 206 may compute resistance value of Ethernet cable 110. As discussed above, frequently such computed resistance value is less than the resistance value that is presumed for the purposes of establishing power margins according to applicable standards. With the computed resistance value, processor 206 may determine that operational components 204 may draw additional power from PSE 102 without exceeding the power allocation specified for the PoE port 106 to which PD 104 is connected. The resistance of Ethernet cable 110 is used, in one example, to compute a usage percentage value reflecting a percentage amount by which the actual resistance of Ethernet cable 110 differs from the resistance assumed for purposes of applicable standards.

In an example, PD 104 comprises a wireless access point (AP), for example, a WiFi access point, such that among the operational components 204 of PD 104 is at least one transceiver for wireless communication with other wireless devices. Increasing the power available to PD 104, specifically, to operational components 204 including a wireless transceiver, may advantageously increase the range and/or quality of the wireless connection between the AP (PD 104) and other devices (not shown). It will be appreciated that other types of PDs can similarly benefit from increased power availability made available through the determination of actual cable resistance.

In another example, PD 104 may communicate information to PSE device 102 regarding either the measured cable resistance value R_{CABLE}, or the aforementioned percentage value, for example. It is contemplated that communication of such information from PD 104 to PSE device 102 may take place over Ethernet cable 110 according to a predetermined data protocol. In this example, PSE device 102 may determine that the surplus power reflected by such a differential percentage of actual cable resistance versus allocated cable resistance at one PoE port 106-1 . . . 106-n, may advantageously be allocated to a different one of PoE ports 106-1 . . . 106-n.

As shown in FIG. 2, PSE device 102 may include a processor 220 and associated memory 222 enabling PSE device 102 to dynamically allocate power to each PoE port 106 based upon information provided from connected PDs 104 regarding the cable resistances of respective Ethernet cables 110 and the resulting power surplus which may be present due to differences between actual cable resistances and allocated cable resistances.

For example, processor 220 may determine, through execution of programming instructions stored in its memory 222 and based upon cable resistance information from one or more PDs 104 as described above, that a surplus of power is available. Processor 220 may in such cases dynamically allocate more power to another of its PoE ports 106. In such cases, PSE device 102 may notify a PD 104 that additional power is available at its PoE port 108 by means of communicating over the Ethernet cable 110 for that PD 104. Again, such communication may be accomplished using a predetermined communications protocol established between PSE device 102 and connected PDs 104.

As shown in FIGS. 1 and 2, PSE device 102 may be connected via a network connection 114 to a network 112. In one example, a network configuration server (not shown) coupled to network 112 may provide configuration information to PSE device 102 specifying a desired allocation of power among multiple PoE ports 106 of PSE device 102. For example, a configuration server may provide configuration information which causes PSE device to allocate any surplus power, as reflected by usage percentage values provided from connected PDs 104, to a particular connected PD 104.

In another example, a configuration server may be coupled to network 112 and may provide configuration information to individual PDs 104 coupled to PSE device 102 either granting or denying particular PDs 104 the ability to increase their usage in the event that measured Ethernet cable losses indicate that surplus power is available.

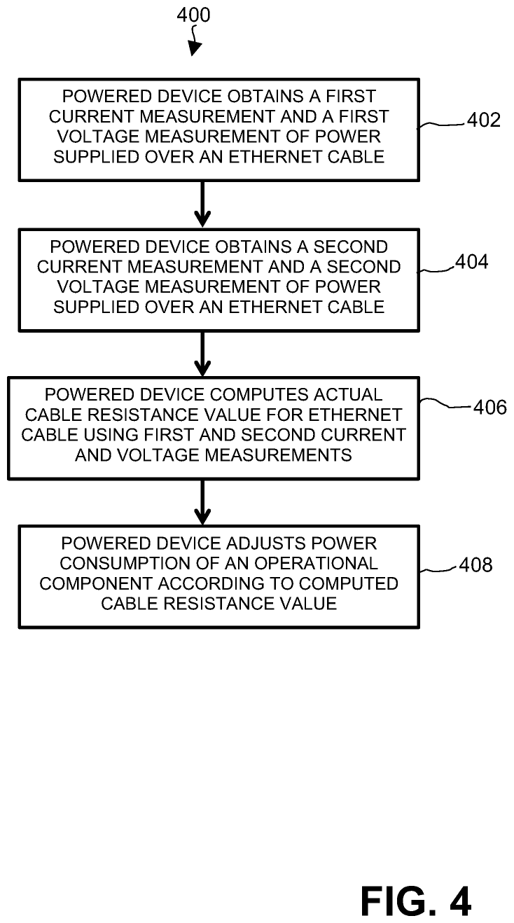

FIG. 4 is a flowchart depicting a method 400 of operation of powered device (PD) 104 according to one example. As shown in FIG. 4, the method 400 of operation includes a block 402 in which, at a time T1, PD 104 obtains a first current measurement and a first voltage measurement from the power supplied to PD via Ethernet cable 110. In block 404, at a time T2, PD 104 obtains a second current measurement and a second voltage measurement from the power supplied via Ethernet cable 110. As noted above, times T1 and T2 are selected such that the respective voltage and current measurements reflect different levels of power consumption by PD 104. In one example, processor 206 in PD 104 controls power monitor 214 to take the first measurements (block 402) during one operational state of PD 104, such as an initialization state, for example, and to take the second measurements (block 404) during another operational state of PD 104, such as after completion of the initialization state.

With continued reference to FIG. 4, in block 406, powered device 104 computes a cable resistance value for Ethernet cable 110 connection PD 104 to PSE device 102. It is contemplated that the cable resistance value may be represented in various forms, such as a value reflecting the resistance of Ethernet cable 110, a value reflecting an amount by which the computed resistance differs from a predetermined value, such as a value established by a PoE standard, or a percentage reflecting a difference between the computed value and a predetermined value.

In block 408, PD 104 adjusts its operation, and hence its power consumption, according to the cable resistance value computed in block 406. In this example, PD 104 may adjust its operation to consume more power than is specified according to an applicable standard for a PD of its rating, without exceeding the level of power provided by PSE 102 according to that standard.

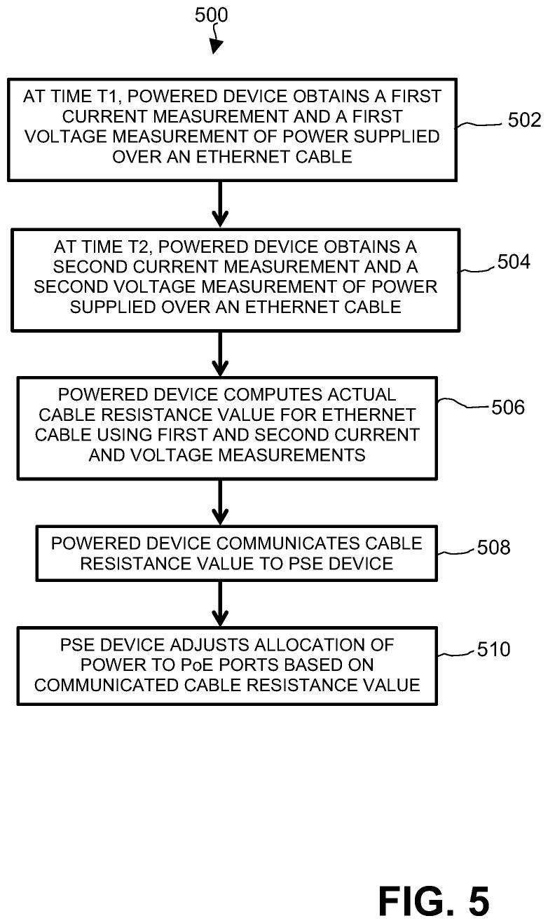

FIG. 5 is a flowchart depicting a method 500 of operation of PoE system 100 according to one example. As shown in FIG. 5, the method 500 of operation includes a block 502 in which, at a time T1, PD 104 obtains a first current measurement and a first voltage measurement from the power supplied to PD via Ethernet cable 110. In block 504, at a time T2, PD 104 obtains a second current measurement and a second voltage measurement from the power supplied via Ethernet cable 110. As noted above, times T1 and T2 are selected such that the respective voltage and current measurements reflect different levels of power consumption by PD 104. In one example, processor 206 in PD 104 controls power monitor 214 to take the first measurements (block 502) during one operational state of PD 104, such as an initialization state, for example, and to take the second measurements (block 504) during another operational state of PD 104, such as after completion of the initialization state.

With continued reference to FIG. 5, in block 506, powered device 104 computes a cable resistance value for Ethernet cable 110 connection PD 104 to PSE device 102. As described above, it is contemplated that the cable resistance value may be represented in various forms, such as a value reflecting the resistance of Ethernet cable 110, a value reflecting an amount by which the computed resistance value differs from (e.g., is less than) the allocated or predetermined resistance value, or a percentage reflecting the difference between the computed value and the allocated or predetermined value.

In block 508, PD 104 communicates the cable resistance value computed in block 506 to PSE device 102. As described above, the cable resistance information may be communicated in the form of a value reflecting a cable resistance value, or in the form of a value corresponding to difference between the computed value and an allocated or predetermined resistance value, or a value corresponding to the percentage of such difference. Finally, in block 510, PSE device 102 adjusts allocation of power delivered to its PoE ports based upon the cable resistance information communicated in block 508 from PD 104.

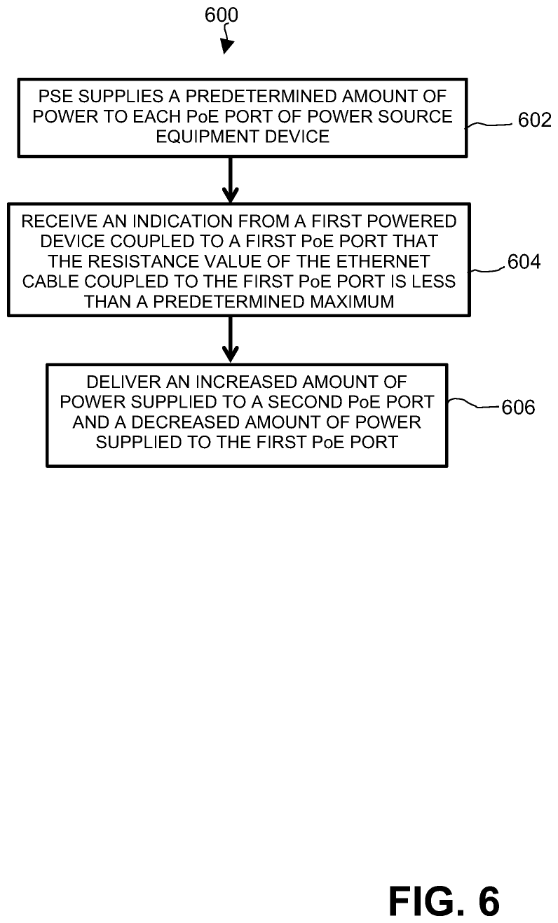

FIG. 6 is a flowchart depicting a method 600 of operation of PSE device 102 in accordance with one example. As shown in FIG. 6, the method 600 of operation begins at block 602 with PSE device 102 supplying a predetermined amount of power to each of its PoE ports. For example, PSE device 102 may supply the amount of power specified by one of the above-referenced IEEE PoE standards.

In block 604 of FIG. 6, PSE device 102 receives an indication from a powered device 104 coupled to a first PoE port 106 of PSE device 102 that the computed resistance value of the Ethernet cable 110 coupling the powered device 104 to the first PoE port is less than a predetermined maximum value. As described herein, the indication from the first powered device may take the form of a computed cable resistance value, a value corresponding to the difference between the computed value and an allocated or predetermined maximum value, or a value reflecting a percentage difference between the computed value and the allocated value.

In response to the indication in block 604, PSE device 102 operates to increase the amount of power supplied to a second PoE port 106 and decreases the amount of power supplied to the first PoE port 106. Through this operation, one PD 104 may take advantage of power that it not used by another PD, while system 100 maintains overall conformance with applicable power delivery and power use standards.

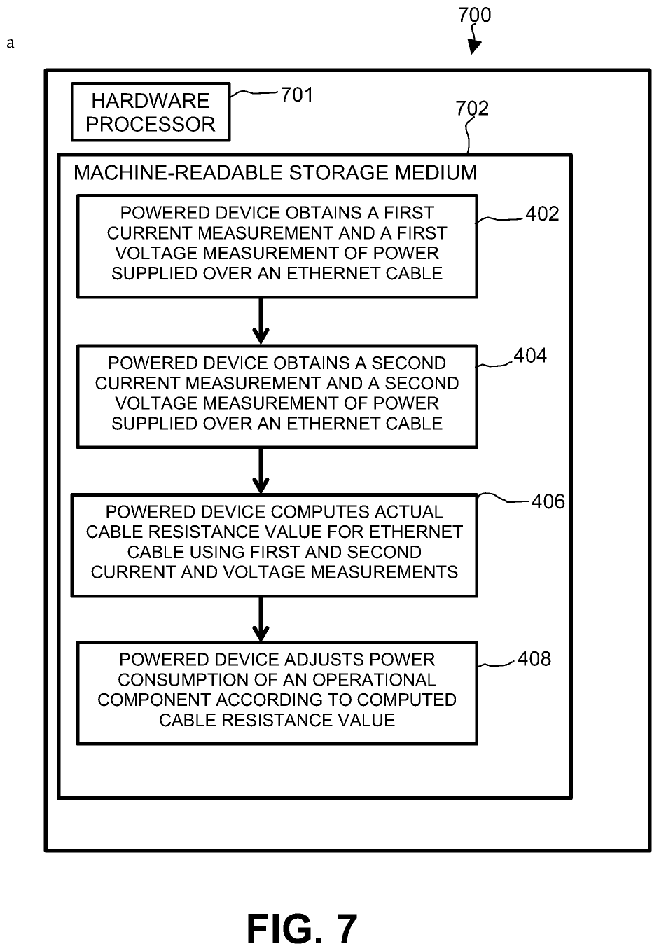

FIG. 7 is a block diagram representing a computing resource 700 implementing a method of operating powered device 104 in PoE system 100 according to one or more disclosed examples. Computing device 700 includes at least one hardware processor 701 and a machine-readable storage medium 702. As illustrated, machine readable medium 702 may store instructions, that when executed by hardware processor 701 (either directly or via emulation/virtualization), cause hardware processor 701 to perform one or more disclosed methods of operating a powered device in a PoE system. In this example, the instructions stored reflect a methodology 400 as described with reference to FIG. 4.

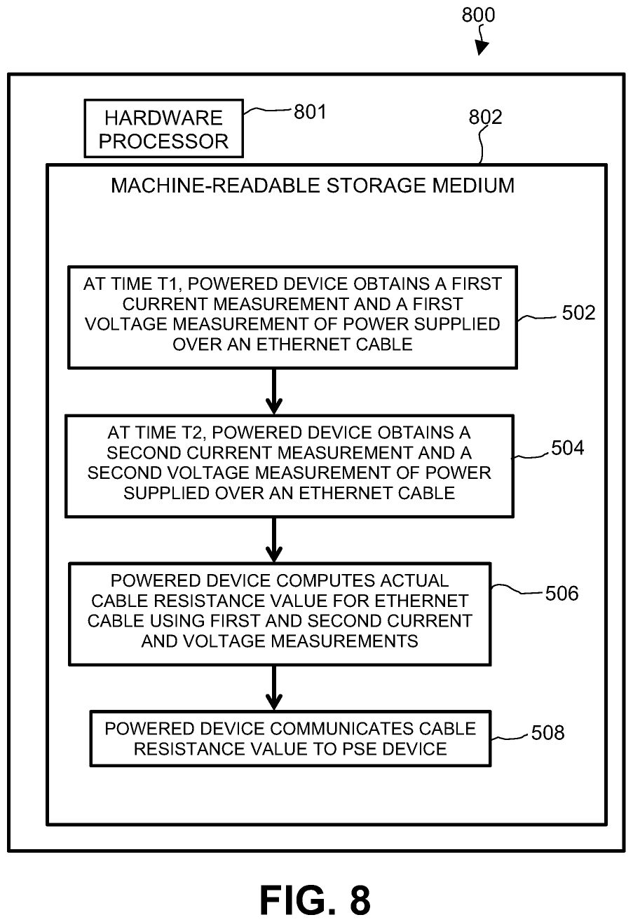

FIG. 8 is a block diagram representing a computing resource 800 implementing a method of operating powered device 104 in PoE system 100, according to one or more disclosed examples. Computing device 800 includes at least one hardware processor 801 and a machine-readable storage medium 802. As illustrated, machine readable medium 802 may store instructions, that when executed by hardware processor 801 (either directly or via emulation/virtualization), cause hardware processor 801 to perform one or more disclosed methods of operating a powered device in a PoE system. In this example, the instructions stored reflect a methodology 500 as described with reference to FIG. 5 to the extent that the method described in FIG. 5 is performed by a powered device.

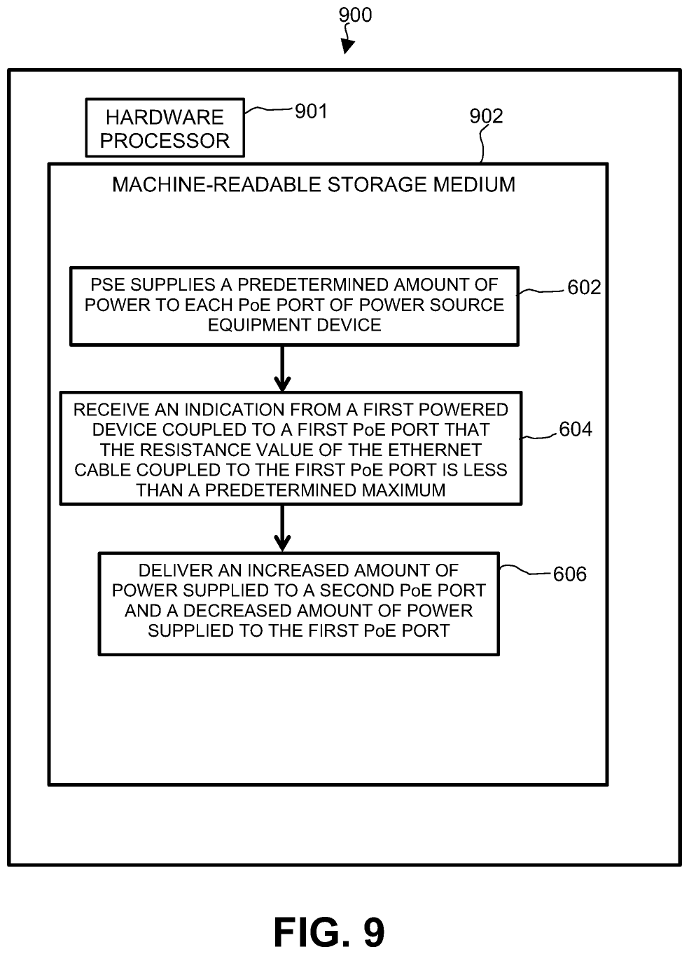

FIG. 9 is a block diagram representing a computing resource 900 implementing a method of operating PSE device 102 according to one or more disclosed examples. Computing device 900 includes at least one hardware processor 901 and a machine-readable storage medium 902. As illustrated, machine readable medium 902 may store instructions, that when executed by hardware processor 901 (either directly or via emulation/virtualization), cause hardware processor 901 to perform one or more disclosed methods of operating a powered device in a PoE system. In this example, the instructions stored reflect a methodology 600 as described with reference to FIG. 6.

Certain terms have been used throughout this description and claims to refer to particular system components. As one skilled in the art will appreciate, different parties may refer to a component by different names. This document does not intend to distinguish between components that differ in name but not function. In this disclosure and claims, the terms “including” and “comprising” are used in an open-ended fashion, and thus should be interpreted to mean “including, but not limited to . . . .” Also, the term “couple” or “couples” is intended to mean either an indirect or direct wired or wireless connection. Thus, if a first device couples to a second device, that connection may be through a direct connection or through an indirect connection via other devices and connections. The recitation “based on” is intended to mean “based at least in part on.” Therefore, if X is based on Y, X may be a function of Y and any number of other factors.

The above discussion is meant to be illustrative of the principles and various implementations of the present disclosure. Numerous variations and modifications will become apparent to those skilled in the art once the above disclosure is fully appreciated. It is intended that the following claims be interpreted to embrace all such variations and modifications.

What is claimed is:

1. A Power-Over-Ethernet (PoE) powered device comprising:
a power interface coupled by an Ethernet cable to a PoE port of a power source equipment device;
a power monitor coupled to the power interface to obtain at least two voltage measurements and at least two current measurements of a power signal supplied on the Ethernet cable; and
a processor coupled to the power monitor to compute a cable resistance value for the Ethernet cable as a function of the at least two voltage and current measurements.

2. The PoE powered device of claim 1, wherein the processor is responsive to the computed cable resistance value to adjust power consumption of a variable power component of the powered device.

3. The PoE powered device of claim 2, wherein the processor is responsive to the computed cable resistance value being less than a predetermined resistance value to increase power consumption of the at least one variable power component.

4. The PoE powered device of claim 2, wherein the at least one variable power component comprises a wireless transceiver.

5. The PoE powered device of claim 2, wherein the processor computes the cable resistance value according to a relation
$${R}_{C A B L E} = \frac{( {V}_{P D 2} - {V}_{P D 1} )}{{I}_{1} - {I}_{2}}$$
where V_{PD1} and I₁ are respective voltage and current values of the Ethernet cable at a first time, V_{PD2} and I₂ are respective voltage and current values of the Ethernet cable at a second time, and R_{CABLE} is the cable resistance value.

6. The PoE powered device of claim 2, wherein the computed cable resistance value is communicated on the Ethernet cable.

7. The PoE powered device of claim 2, wherein the computed cable resistance value reflects a percentage by which the cable resistance differs from a predetermined value.

8. A Power-Over-Ethernet (PoE) system, comprising:
a power source equipment device having a PoE port, the power source equipment device operable to distribute power to the PoE port;
a powered device coupled to the PoE port by an Ethernet cable having a resistance, the powered device including:
a power monitor for obtaining voltage and current measurements of a power signal supplied on the Ethernet cable; and
a processor for computing a resistance value for the Ethernet cable based on the voltage and current measurements obtained by the power monitor.

9. The PoE system of claim 8, wherein the voltage and current measurements comprise at least two voltage measurements and at least two current measurements obtained at at least two different times.

10. The PoE system of claim 8, wherein the processor is responsive to the computed resistance value to adjust an amount of power drawn by the powered device from the PoE port.

11. The PoE system of claim 8, wherein the processor is responsive to a computed resistance value that is less than a predetermined value to to increase the amount of power drawn by the powered device from the PoE port.

12. The PoE system of claim 8, wherein the processor computes the resistance value according to a relation
$${R}_{C A B L E} = \frac{( {V}_{P D 2} - {V}_{P D 1} )}{{I}_{1} - {I}_{2}}$$
where V_{PD1} and I₁ are respective voltage and current values of the Ethernet cable at a first time, V_{PD2} and I₂ are respective voltage and current values of the Ethernet cable at a second time, and R_{CABLE} is the cable resistance value.

13. The PoE system of claim 8, wherein the computed resistance value is communicated on the Ethernet cable to the power source equipment device.

14. The PoE system of claim 8, wherein the resistance value reflects a percentage by which the resistance differs from a predetermined value.

15. A method for operating a powered device in a Power-Over-Ethernet (PoE) system, comprising:
monitoring a power signal supplied by an Ethernet cable to the powered device from a PoE port of a power source equipment device to obtain at least two voltage measurements and at least two current measurements of the power signal; and
computing a cable resistance value for the Ethernet cable based on the at least two voltage and current measurements.

16. The method of claim 15, further comprising:
adjusting power consumption of at least one variable power component of the powered device according to the computed cable resistance value.

17. The method of claim 15, wherein computing the cable resistance value of the Ethernet cable comprises computing a resistance value R_{CABLE} according to the relation
$${R}_{C A B L E} = \frac{( {V}_{P D 2} - {V}_{P D 1} )}{{I}_{1} - {I}_{2}}$$
where V_{PD1} and I₁ are respective voltage and current values of the Ethernet cable at a first time, and V_{PD2} and I₂ are respective voltage and current values of the Ethernet cable at a second time.

18. The method of claim 16, wherein adjusting power consumption of the at least one variable power component of the powered device comprises increasing power consumption of the variable power component in response to the computed cable resistance value being less than a predetermined value.

19. The method of claim 15, further comprising:
communicating the computed cable resistance value to the power source equipment device.

20. The method of claim 15, wherein the computed cable resistance value reflects a percentage by which the cable resistance differs from a predetermined value.
